(19) United States
(12) Patent Application Publication
(10) Pub. No.: US 2010/0248500 A1
(43) Pub. Date: Sep. 30, 2010

(54) MOTOR DRIVER AND CONNECTION APPARATUS THEREOF

(75) Inventors: CHIN-HSIEN TING, Tu-Cheng (TW); CHIH-JUNG LIU, Tucheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/430,126

(22) Filed: Apr. 27, 2009

(30) Foreign Application Priority Data
Mar. 25, 2009 (CN) 200910301132.7

(51) Int. Cl. H01R 12/00

(52) U.S. Cl. 439/55

(57) ABSTRACT

A motor driver includes a circuit board and a connection apparatus. The connection apparatus includes two connection components. Each connection component includes two connection portions and a number of pins. The two connection components are mounted to the circuit board to connect to a positive pole and a negative pole of the circuit board correspondingly via the number of pins. The two connection portions are configured for being connected to wires.

### BACKGROUND

1. Technical Field

The present disclosure relates to a motor driver and a connection apparatus of the motor driver.

2. Description of Related Art

In the field of industrial controls, a plurality of motors together used in a system is common. As a result, there must be a plurality of motor drivers to control the motors. However, connecting wires among the plurality of motor drivers for them to use a common power supply is not an easy task.

### BRIEF DESCRIPTION OF THE DRAWINGS

FIG. 1 is an exploded, isometric partial view of an exemplary embodiment of a circuit board of a motor driver, including a connection apparatus.

FIG. 2 is an assembled view of the connection apparatus and circuit board of FIG. 1.

FIG. 3 is an isometric view of three motor drivers each using the connection apparatus of FIG. 1.

### DETAILED DESCRIPTION

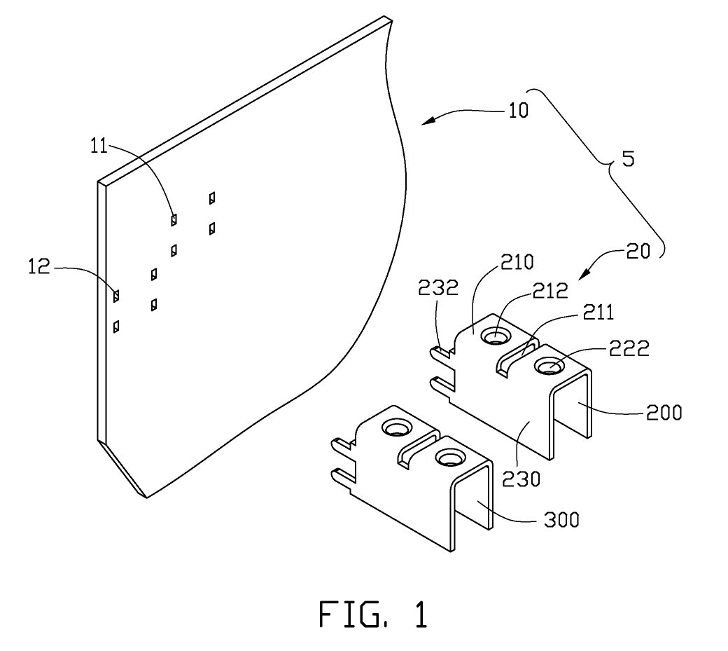

Referring to FIG. 1, an exemplary embodiment of a motor driver 5 includes a circuit board 10 and a connection apparatus 20. The connection apparatus 20 includes a first connection component 200 and a second connection component 300. In one embodiment, the first connection component 200 and the second connection component 300 have the same configuration. It can be understood that the motor driver 5 further includes other components, such as a controller, however they are not shown in FIG. 1.

Each of the first and second connection components 200 and 300 includes a base 210, two sidewalls 230 perpendicularly extending from opposite sides of the base 210, and two pairs of pins 232 extending from a corresponding end of each sidewall 230. The base 210 defines a slot 211, and two connection portions 212 and 222 located at opposite sides of the slot 211. In the embodiment, the connection portions 212 and 222 are screw holes.

The circuit board 10 includes a first group of vias 11 electrically connected to a positive pole of the circuit board 10, and a second group of vias 12 electrically connected to a negative pole of the circuit board 10. Each group of the first and second groups of vias 11 and 12 includes two pairs of vias. The first group of vias 11 is configured to mount the first connection portion 200. The second group of vias 12 is configured to mount the second connection portion 300.

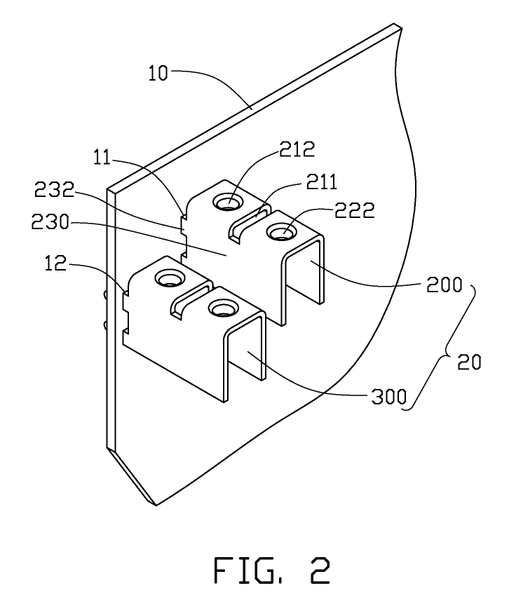

Referring to FIG. 2, in assembly, the pins 232 of the first connection component 200 are inserted into the first group of vias 11 of the circuit board 10, and the pins 232 of the second connection component 300 are inserted into the second group of vias 12 of the circuit board 10. As a result, the first connection component 200 is electronically coupled to the positive pole of the circuit board 10, and the second connection component 300 is electronically coupled to the negative pole of the circuit board 10. In other embodiments, the pins 232 of the first and second connection components 200, 300 can be welded together with the circuit board 10.

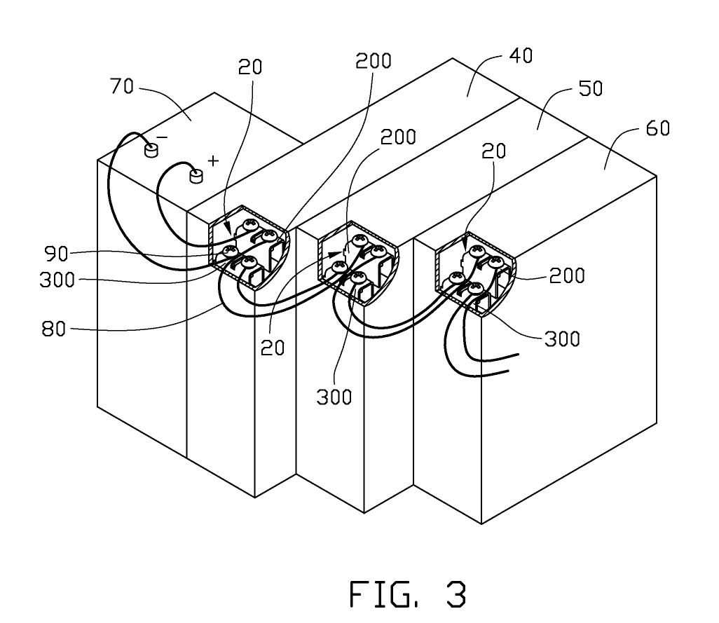

Referring to FIG. 3, three motor drivers 40, 50, and 60 with different specifications share a power supply 70. Each motor driver 40, 50, 60 includes a connection apparatus 20. In use, a positive pole of the power supply 70 is electronically coupled to the connection portion 212 of the first connection component 200 of the motor driver 40, and a negative pole of the power supply 70 is electronically coupled to the connection portion 212 of the second connection component 300 of the motor driver 40. The connection portion 222 of the first connection component 200 of the motor driver 40 is electronically coupled to the connection portion 212 of the first connection component 200 of the motor driver 50, and the connection portion 222 of the second connection component 300 of the motor driver 40 is electronically coupled to the connection portion 212 of the second connection component 300 of the motor driver 50. The connection portion 222 of the first connection component 200 of the motor driver 50 is electronically coupled to the connection portion 212 of the first connection component 200 of the motor driver 60, and the connection portion 222 of the second connection component 300 of the motor driver 50 is electronically coupled to the connection portion 212 of the second connection component 300 of the motor driver 60. As a result, the motor drivers 40, 50, and 60 can conveniently share the power supply 70. It can be understood that one motor driver is electronically coupled to another motor driver via wires 80, the motor driver 40 is electronically coupled to the power supply 70 via the wires 80, and the wires 80 are connected to the connection portions 212 and 222 via screws 90.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A motor driver comprising:
a circuit board; and
a connection apparatus comprising two connection components, each connection component comprising two connection portions and a plurality of pins, wherein the two connection components are for being mounted to the circuit board to connect to a positive pole and a negative pole of the circuit board correspondingly via the plurality of pins, the two connection portions of each connection component are configured for being electrically connected to wires.

2. The motor driver of claim 1, wherein each connection component comprises a base, the two connection portions are formed on the base.

3. The motor driver of claim 2, wherein each connection component comprises two sidewalls extending from opposite sides of the base, and the plurality of pins comprise two pairs of pins extending from corresponding ends of the sidewalls, wherein the circuit board comprises two pairs of vias corresponding to the two pairs of pins of each connection component.

4. The motor driver of claim 1, wherein each connection component defines a slot, the two connection portions of each connection component are located at opposite sides of the slot.

5. The motor driver of claim 1, wherein each connection portion is a screw hole defined in a corresponding connection component, the connection portion is configured to be electrically connected to a wire via a screw.

6. A connection apparatus comprising two connection components, wherein each connection component comprises two connection portions and at least one pin, the connection components are configured for being mounted to a circuit board to connect to a positive pole and a negative pole of the circuit board correspondingly via the pin, the connection portions are configured for being electrically connected to wires.

7. The connection apparatus of claim 6, wherein each connection component comprises a base, the two connection portions are formed on the base.

8. The connection apparatus of claim 7, wherein each connection component comprises two sidewalls perpendicularly extending from opposite sides of the base, wherein the at least one pin is extending from an end of one of the sidewalls.

9. The connection apparatus of claim 6, wherein each connection component defines a slot, the two connection portions of each connection component are located at opposite sides of the slot.

10. The connection apparatus of claim 6, wherein each connection portion is a screw hole, configured for being electrically connected to a wire via a screw.

11. A motor driver assembly supplied by a power supply, the motor driver assembly comprising:
at least two motor drivers, wherein said at least two motor drivers comprises a first motor driver and a second motor driver, each of the first and second motor drivers comprises:
a circuit board; and
a connection apparatus electrically connected to the circuit board, and comprising a first connection component and a second connection component, wherein each of the first and second connection components comprises a first connection portion and a second connection portion;
wherein the first connection portion of the first connection component of the first motor driver is configured to be connected to a positive pole of the power supply, and the first connection portion of the second connection component of the first motor driver is configured to be connected to a negative pole of the power supply; and
wherein the second connection of the first connection component of the first motor driver is connected to the first connection portion of the first connection component of the second motor driver, and the second connection portion of the second connection component of the first motor driver is connected to the first connection portion of the second connection component of the second motor driver.

12. The motor driver assembly of claim 11, wherein said at least two motor drivers further comprises a third motor driver, the third motor driver comprises:
a circuit board; and
a connection apparatus electrically connected to the circuit board of the third motor driver, and comprising a first connection component and a second connection component, wherein each of the first and second connection components comprises a first connection portion and a second connection portion;
wherein the second connection of the first connection component of the second motor driver is connected to the first connection portion of the first connection component of the third motor driver, and the second connection portion of the second connection component of the second motor driver is connected to the first connection portion of the second connection component of the third motor driver.
